(19) United States
(12) Patent Application Publication
(10) Pub. No.: US 2005/0019073 A1
(43) Pub. Date: Jan. 27, 2005

(54) Image forming device

(75) Inventor: Makoto Hattori, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/896,236

(22) Filed: Jul. 22, 2004

(30) Foreign Application Priority Data
Jul. 23, 2003 (JP) 2003-278127

(51) Int. Cl. G03G 15/00

(52) U.S. Cl. 399/388; 399/390

(57) ABSTRACT

An image forming device includes an image forming section, a plurality of recording-medium supply units, a transportation guide forming a plurality of transportation paths, a full-width cleaning member, a plurality of recording-medium separating members, and at least one partial cleaning member provided for each recording-medium separating member. The plurality of transportation paths joins together to provide a single main transportation path reaching the image forming section. The full-width cleaning member is disposed in the single main transportation path. The full-width cleaning member has a full-width cleaning portion wider than a recording medium. Each partial cleaning member has a partial cleaning portion wider than is the corresponding recording-medium separating member.

### BACKGROUND OF THE INVENTION

1. Field of the Invention

The present invention relates to an image forming device such as a laser printer.

2. Description of Related Art

An image forming device such as a laser printer is usually provided with a paper feed mechanism for feeding paper and an image forming mechanism for forming an image on the fed paper.

The paper feed mechanism is provided with a paper feed tray in which paper is stacked in a pile, and a paper feed roller and a paper feed pad disposed above one end of the paper feed tray and disposed to confront each other. Paper at the top of the paper feed tray is pinched between the paper feed roller and the paper feed pad by rotation of the paper feed roller, and is fed one sheet at a time.

The image forming mechanism is provided with a photosensitive drum and, around the photosensitive drum, a charging device, a scanner device, a developing roller, and a transfer roller, in that order following the direction of rotation of the photosensitive drum. As the photosensitive drum rotates, the surface of the photosensitive drum is first uniformly charged by the charging device, then exposed by high-speed laser beam scan from the scanner device, and an electrostatic latent image is formed based on predetermined image data. Next, through rotation of the developing roller, toner held on the developing roller is supplied to the electrostatic latent image formed on the surface of the photosensitive drum and held selectively, whereby a visible image is formed. Then, while paper fed from the paper feed mechanism passes between the photosensitive drum and the transfer roller, the visible image held on the surface of the photosensitive drum is transferred to the paper, thereby forming a predetermined image on the paper.

In the above-described image forming device, since paper is fed one sheet at a time while being pinched between the paper feed roller and the separation pad, paper dust may be generated on the paper due to friction between the paper feed roller and the separation pad. In addition, foreign matter such as paper dust may be generated over the entirety of the paper when the paper is cut. If such paper dust mixes with the toner in the image forming mechanism, a problem of image quality degradation will occur.

Accordingly, for example, Japanese patent-application publication No. 2003-81476 discloses a device in which a paper dust removing roller of approximately the same width as the separation pad, and a paper dust removing roller of approximately the same width as the paper, are disposed downstream of the paper feed roller in the paper transportation direction. Thus, paper dust generated on paper can be eliminated in a well-balanced manner before the paper is transported to the image forming mechanism.

### SUMMARY OF THE INVENTION

However, in the device disclosed in Japanese patent-application publication No. 2003-81476, the dust removing rollers of approximately the same width as the paper are not provided for all paper feed paths, resulting in a problem of failing to eliminate paper dust generated on paper in a well-balanced manner for all the paper used.

In view of the above-described drawbacks, it is an objective of the present invention to provide an image forming device that can eliminate foreign matter effectively, and can form high-quality images, for paper transported from any paper feed path in the image forming device.

In order to attain the above and other objects, the present invention provides an image forming device. An image forming device includes an image forming section, a plurality of recording-medium supply units, a transportation guide, a full-width cleaning member, a plurality of recording-medium separating members, and at least one partial cleaning member provided for each recording-medium separating member. The image forming section forms an image on an image formation surface of a recording medium. The recording medium has a width in a widthwise direction orthogonal to a recording-medium transportation direction. Each of the plurality of recording-medium supply units supplies the image forming section with the recoding medium. The transportation guide forms a plurality of transportation paths. Each transportation path connects a corresponding one of the plurality of recording-medium supply units to the image forming section. The recording medium is transported from each recording-medium supply unit to the image forming section in the recording-medium transportation direction. The plurality of transportation paths joins together to provide a single main transportation path reaching the image forming section. The full-width cleaning member is disposed in the single main transportation path. The full-width cleaning member is contactable with the image formation surface of the recording medium. The full-width cleaning member has a full-width cleaning portion for removing foreign matter adhering to the image formation surface of the recording medium. The full-width cleaning portion has a first width greater than the width of the recording medium in the widthwise direction. Each of the plurality of recording-medium separating members is disposed at a position, in each of the plurality of transportation paths, between a corresponding recording-medium supply unit and the full-width cleaning member. Each recording-medium separating member is contactable with one surface of the recording medium, thereby separating only one sheet of the recording medium to be transported downstream. Each recording-medium separating member has a second width in the widthwise direction smaller than the width of the recording medium. The at least one partial cleaning member is provided for each recording-medium separating member. The at least one partial cleaning member is disposed at a position, in a corresponding transportation path, between a corresponding recording-medium separating member and the image forming section. Each partial cleaning member is contactable with the one surface of the recording medium. Each partial cleaning member has a partial cleaning portion for removing foreign matter adhering to the one surface of the recording medium. The partial cleaning portion has a third width greater than the second width of the corresponding recording-medium separating member.

### BRIEF DESCRIPTION OF THE DRAWINGS

The above and other objects, features and advantages of the invention will become more apparent from reading the following description of the preferred embodiments taken in connection with the accompanying drawings in which:

FIG. 1 is a side cross-sectional view showing principal parts of a laser printer according to an embodiment of the present invention;

FIG. 2 is an enlarged side cross-sectional view showing paper feed transportation paths of the laser printer shown in FIG. 1;

FIG. 3(a) is a plan view of paper used in the laser printer shown in FIG. 1;

FIG. 3(b) is a cross-sectional view of a third paper dust removing roller in the laser printer shown in FIG. 1;

FIG. 3(c) is a cross-sectional view of a first paper dust removing roller and a second paper dust removing roller in the laser printer shown in FIG. 1;

FIG. 3(d) is a cross-sectional view of a pad member in the laser printer shown in FIG. 1; and

FIG. 4 is a side view of a paper dust transportation section of the laser printer shown in FIG. 1.

### DETAILED DESCRIPTION OF THE PREFERRED EMBODIMENTS

An image forming device according to a preferred embodiment of the present invention will be described while referring to the accompanying drawings.

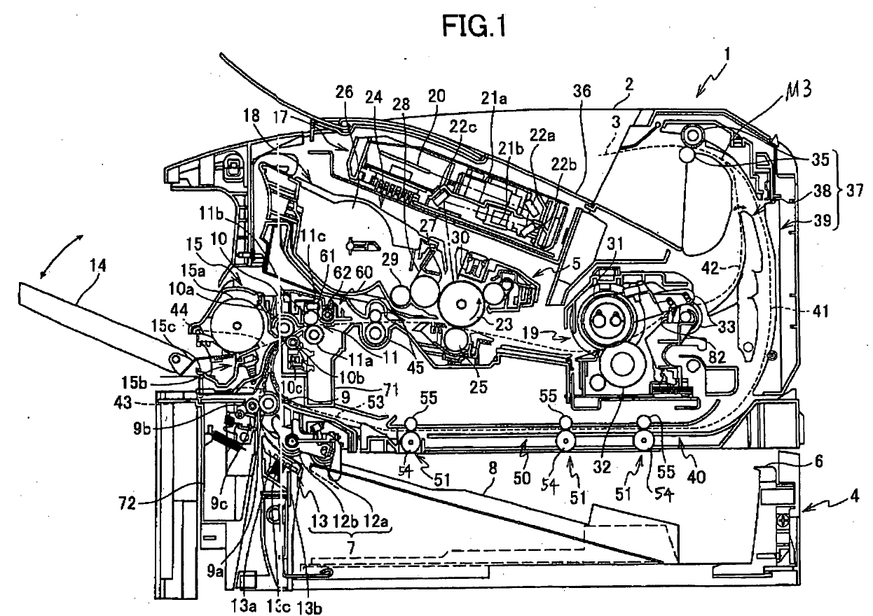

As shown in FIG. 1, a laser printer 1 forms an image by electrophotography, and is provided with, in a main casing 2, a paper supply cassette 4 for feeding paper 3 as a recording medium, an image forming section 5 for forming predetermined images on the fed paper 3, and so forth.

The paper supply cassette 4 is disposed, in the bottom area within the main casing 2. The paper supply cassette 4 includes a removable paper feed tray 6, a paper feed mechanism section 7 fitted to one end of the paper feed tray 6, a paper pressure plate 8 fitted inside the paper feed tray 6, a first transportation section 9 located downstream in a paper transportation direction with respect to the paper feed mechanism section 7 (hereinafter, “upstream in the paper transportation direction” and “downstream in the paper transportation direction” may be referred to simply as “upstream” and “downstream”), a second transportation section 10 and a third transportation section 11, and registration rollers 45 located downstream in the paper transportation direction with respect to the first transportation section 9 and the second transportation section 10.

The paper feed tray 6 is box-shaped and has a top that can be opened to allow the paper 3 to be accommodated. The paper feed tray 6 can be inserted into and removed from the bottom part of the main casing 2 horizontally.

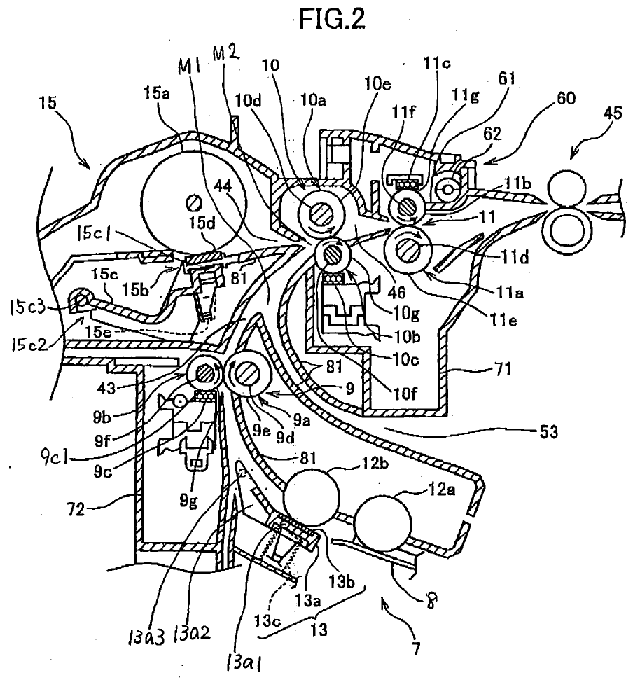

As shown in FIGS. 1 and 2, the paper feed mechanism section 7 includes a pickup roller 12a that picks up the paper 3 on the paper pressure plate 8, a separation roller 12b that has a surface with a higher coefficient of friction than a coefficient of friction of a pad member 13b described later, and a separation pad 13 confronting the separation roller 12b. The separation pad 13 includes a support frame 13a, the pad member 13b, and a spring 13c.

The pickup roller 12a picks up the paper 3 on the paper pressure plate 8, and feeds the paper 3 to the separation roller 12b side in a first transportation path 43.

The separation roller 12b is positioned in the first transportation path 43 so as to pinch the paper 3 picked up by the pickup roller 12a between the separation roller 12b and the pad member 13b, such that one sheet of the paper 3 is transported downstream in the paper transportation direction.

As shown in FIG. 2, the support frame 13a includes a flat plate-shaped member 13a1 and a support member 13a2, and is formed as a member with an L-shaped cross section. The flat plate-shaped member 13a1 is disposed below the separation roller 12b and confronts the separation roller 12b. The support member 13a2 is connected to one end of the flat plate-shaped member 13a1, and is formed to bend downward approximately at a right-angle from the one end of the flat plate-shaped member 13a1. An upper end portion 13a3 of the support member 13a2 is pivotally supported to a casing (not shown), such that the separation pad 13 can be pivotally moved. The pad member 13b is inset in a concave portion on the side of the flat plate-shaped member 13a1 that confronts the separation roller 12b. The spring 13c is disposed on the other side that is an opposite side to the separation roller 12b. The spring 13c urges the flat plate-shaped member 13a1, such that the pad member 13b is pressed against the separation roller 12b.

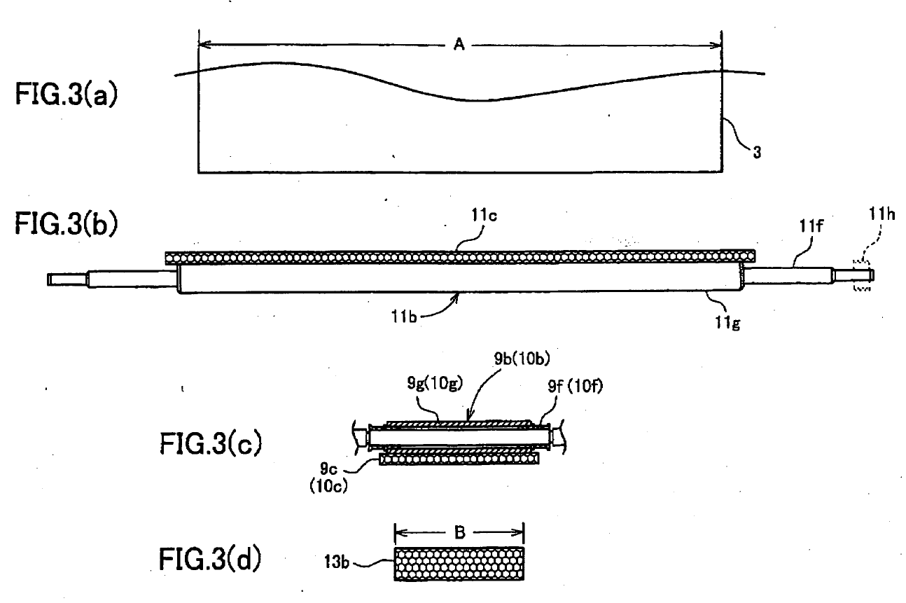

As shown in FIG. 3(d), the pad member 13b has an approximately rectangular plate shape and is formed from a urethane rubber or similar elastic member. A width B of the pad member 13b in the widthwise direction orthogonal to the paper transportation direction (hereinafter “width in the direction orthogonal to the paper transportation direction” may be referred to simply as “width”) is smaller than a width A of the paper 3 shown in FIG. 3(a). The width A is the maximum width of the paper 3 for which printing can be performed by the laser printer 1. In other words, the pad member 13b has a width that provides contact with only the widthwise center part of the paper 3 for feeding the paper 3.

As shown in FIG. 1, the paper pressure plate 8 allows the paper 3 to be stacked in a pile. The paper pressure plate 8 is pivotally supported about the farther end from the pickup roller 12a, enabling its nearer end to move up and down. The paper pressure plate 8 is raised by a pressure plate raising mechanism (not shown). At this time, topmost paper 3 contacts the pickup roller 12a and further raises the pickup roller 12a, and stops at a position at which a sensor (not shown) detects the pickup roller 12a. The pickup roller 12a is forced downward by a spring (not shown) and is pressed against the paper pressure plate 8. Then the topmost paper 3 is picked up by the rotation of the pickup roller 12a and transported to the separation roller 12b. By being pinched between the separation roller 12b and the pad member 13b, the paper 3 is separated and fed one sheet at a time by the cooperative action of the separation roller 12b and the pad member 13b. The first transportation path 43 is formed by a transportation guide 81 between the paper feed mechanism section 7 and the image forming section 5. The fed paper 3 is sent to the registration rollers 45 by the first transportation section 9, the second transportation section 10, and the third transportation section 11, along the first transportation path 43. The registration rollers 45 include a pair of rollers. The registration rollers 45 send the paper 3 to the image forming section 5 after predetermined registration of the paper 3.

As shown in FIG. 1, the image forming section 5 includes a scanner section 17, a process section 18, a fixing section 19, and so forth.

The scanner section 17 is disposed in an upper area within the main casing 2, and includes a laser emitting section (not shown), a polygonal mirror 20, lenses 21a and 21b, reflecting mirrors 22a through 22c, and so forth. In the scanner section 17, a laser beam based on predetermined image data emitted from the laser emitting section is irradiated through or reflected from the polygonal mirror 20, the lens 21a, the reflecting mirrors 22a and 22b, the lens 21b, and the reflecting mirror 22c, in this order, as shown by the single-dot chain line, and is irradiated onto the surface of a photosensitive drum 23 of the process section 18 in a high-speed scan.

The process section 18 is positioned below the scanner section 17, and is detachably mounted in the main casing 2. The process section 18 includes the photosensitive drum 23, a developing cartridge 24, a transfer roller 25, and a scorotron-type charger 30. The developing cartridge 24 is detachably mounted to the process section 18, and includes a toner container 26, a developing roller 27, a thickness regulating blade 28, a toner supply roller 29, and so forth.

The toner container 26 is filled with positively charged, non-magnetic, single-component polymer toner. The toner is supplied to the developing roller 27 by the toner supply roller 29, and is held on the developing roller 27 as a thin layer of a certain thickness by the scraping action of the thickness regulating blade 28. The photosensitive drum 23 is positioned to confront the developing roller 27, and is rotatable. The drum body of the photosensitive drum 23 is grounded, and is formed of a positively-charged photosensitive layer formed from polycarbonate or the like.

As the photosensitive drum 23 rotates in the direction indicated by the arrow, the surface of the photosensitive drum 23 is uniformly positively charged by the scorotron-type charger 30, and is then exposed by a high-speed laser S beam scan by the scanner section 17, and an electrostatic latent image is formed. Subsequently, when the photosensitive drum 23 is opposed to the developing roller 27, the positively-charged toner held on the developing roller 27 is supplied to and selectively held by the electrostatic latent image formed on the surface of the photosensitive drum 23, that is, portions exposed by the laser beam and whose potential has fallen on the surface of the uniformly positively-charged photosensitive drum 23. In this way, the image becomes visible and transfer developing can be performed.

The transfer roller 25 is located below and confronts the photosensitive drum 23. The transfer roller 25 has a roller of conductive rubber material covering a metallic roller shaft, and has a predetermined transfer bias applied with respect to the photosensitive drum 23. Thus, the visible image held on the photosensitive drum 23 is transferred to the paper 3 while the paper 3 passes between the photosensitive drum 23 and the transfer roller 25. Then the paper 3 onto which the visible image has been transferred is transported to the fixing section 19.

The fixing section 19 is located downstream of the process section 18. The fixing section 19 includes a heating roller 31, a pressure roller 32 that applies pressure to the heating roller 31, and a transport rollers 33 located downstream of the heating roller 31 and the pressure roller 32.

The heating roller 31 is metallic and is provided with a halogen lamp for heating. While the paper 3 passes between the heating roller 31 and the pressure roller 32, the heating roller 31 heat-fixes the toner transferred onto the paper 3 in the process section 18. Then the paper 3 is transported to the paper discharge rollers 35 by the transport rollers 33 of the fixing section 19. After being transported to the paper discharge rollers 35, the paper 3 is discharged onto a discharge tray 36.

A paper sensor 82 is disposed between the heating roller 31 and the transport rollers 33. At the time of reverse transportation of the paper 3 described later, when the rear end of the paper 3 is detected by the paper sensor 82, the paper discharge rollers 35 are switched from forward rotation to reverse rotation at predetermined timing after the detection timing.

With the laser printer 1, the developing roller 27 recovers residual toner remaining on the surface of the photosensitive drum 23 after the transfer roller 25 has performed transfer. That is, the residual toner is recovered by a so-called cleanerless developing method since the residual toner is recovered by the cleanerless developing method, there is no need for a special member such as a blade for storing removing residual toner, or for a storage section for waste toner, thereby simplifying the device configuration.

The laser printer 1 is provided with the reverse mechanism 37 that reverses the paper 3, and a retransportation tray 40 that retransports the paper 3 to the image forming section 5 in order to form images on both sides of the paper 3. The reverse mechanism 37 includes the paper discharge rollers 35, a flapper 38, and a reverse guide 39. The reverse mechanism 37 and the retransportation tray 40 may be integrated and detachably mounted to the main casing 2 as a unit.

The paper discharge rollers 35 include a pair of rollers, and enable switching between forward and reverse rotation. As described above, when the paper 3 is to be discharged onto the discharge tray 36, the paper discharge rollers 35 rotate in the forward direction and transport the paper 3 in the paper transportation direction. However, when the paper 3 is to be reversed and transported in the reverse direction, the paper discharge rollers 35 rotate in the reverse direction.

The reverse guide 39 forms a reverse transportation path 41 in a vertical direction together with the flapper 38 so that the paper 3 can be transported from the paper discharge rollers 35 to the retransportation tray 40 located below the image forming section 5. The upstream end of the reverse transportation path 41 is located near the paper discharge rollers 35 and the downstream end thereof is located near the retransportation tray 40. In the reverse transportation path, the paper 3 is transported with its widthwise center as a reference (instead of transporting the paper 3 with its widthwise end as a reference), which is so-called center registration feed.

The flapper 38 is provided near a junction position M3 that is a junction of a paper discharge path 42 and the reverse transportation path 41. The flapper 38 can be pivotally moved. More specifically, the flapper 38 can switch the transportation direction of the paper 3 reversed by the paper discharge rollers 35, from the direction toward the paper discharge rollers 35 to the direction toward the retransportation tray 40 in accordance with excitation or non-excitation of a solenoid (not shown).

The retransportation tray 40 is approximately plate-shaped, and is disposed approximately horizontally above the paper feed tray 6. The upstream end of the retransportation tray 40 is located near the rear end of the reverse transportation path 41, and the downstream end is located below the registration rollers 45.

The reverse mechanism 37 is operated as described below. When the paper 3 with an image formed on one side is fed from the paper discharge path 42 to the paper discharge rollers 35 by the transport rollers 33, the paper discharge rollers 35 rotate forward while pinching the paper 3 and transport the paper 3 initially toward the outside (the discharge tray 36 side). Subsequently, when a greater part of the paper 3 has been fed toward the outside and the rear end of the paper 3 is between the paper discharge rollers 35, forward rotation is halted. Next, the paper discharge rollers 35 rotate in the reverse direction, and the flapper 38 switches the transportation direction so that the paper 3 is transported to the reverse transportation path 41. Thus, the paper 3 is transported to the reverse transportation path 41 with its lengthwise direction reversed. The timing for switchover of the paper discharge rollers 35 from forward to reverse rotation is controlled so as to be a predetermined time after the rear end of the paper 3 is detected by the paper sensor 82, as described above. When transportation of the paper 3 ends, the flapper 38 is switched to its original state, that is, the state in which the paper 3 fed from the transport rollers 33 is fed to the paper discharge rollers 35. Next, the paper 3 transported in the reverse direction to the reverse transportation path 41 is further transported to the retransportation tray 40. Then, the paper 3 is transported upward from the retransportation tray 40, and transported to the registration rollers 45. The paper 3 transported to the registration rollers 45 has predetermined registration applied again in the reversed state, and is then sent toward the image forming section 5, by which a predetermined image is formed on the reverse side of the paper 3.

The retransportation tray 40 includes a tray body 50 and oblique rollers 51. The tray body 50 has an approximately rectangular plate shape, and is disposed approximately horizontally above the paper feed tray 6. The upstream end of the tray body 50 is connected to the reverse guide 39. The downstream end of the tray body 50 is connected to a retransportation path 53 that is connected to the first transportation path 43, in order to guide the paper 3 from the tray body 50 to the second transportation section 10.

The three oblique rollers 51 are provided in the tray body 50 at predetermined intervals along the paper transportation direction for transporting the paper 3. The paper 3 is transported while in contact with a reference plate (not shown).

Each oblique roller 51 is provided with an oblique drive roller 54 and an oblique follow roller 55. The oblique drive roller 54 is located near the reference plate (not shown) disposed at one widthwise end of the tray body 50. The axes of the oblique drive rollers 54 are positioned 5 in a direction approximately orthogonal to the paper transportation direction. The oblique follow roller 55 confronts the oblique drive roller 54 and sandwiches the paper 3 with the oblique drive roller 54. The axes of the oblique follow rollers 55 are positioned such that the paper 3 is transported in a direction oblique with regard to the paper transport direction toward the reference plate.

The paper 3 sent from the reverse transportation path 41 to the tray body 50 is transported by the oblique rollers 51 via the retransportation path 53 while one widthwise edge of the paper 3 is in contact with the reference plate, and toward the image forming section 5, with the front and back reversed. When the paper 3 is transported to the image forming section 5, the rear surface thereof is brought into contact with the photosensitive drum 23, the visible image is transferred and then fixed by the fixing section 19, and the paper 3 is discharged to the discharge tray 36 with images formed on both sides.

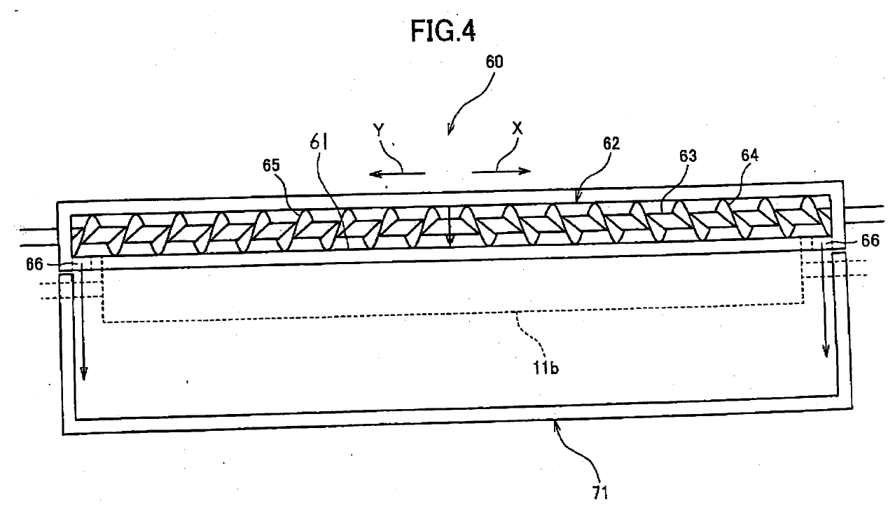

As shown in FIG. 2, the laser printer 1 is provided with the first transportation section 9, the second transportation section 10, and the third transportation section 11, all positioned in the first transportation path 43. With this construction, the laser printer 1 can remove, in a well-balanced manner, paper dust originally generated on the entire paper 3 when the paper 3 is cut and paper dust generated on the surface of the paper 3 due to friction between the pad member 13b and the separation roller 12b of the paper feed mechanism section 7. Also, as shown in FIG. 4, a paper dust transportation section 60 is provided to transport paper dust removed by the third transportation section 11 to a storage tank 71 described later.

The relationships among the transportation paths 43, 44, 46, and 53 are described. The first transportation path 43, the second transportation path 44, the transportation path 46, and the retransportation path 53 are formed by the transportation guide 81. The first transportation path 43 is formed to pass through the paper feed mechanism section 7, the first transportation section 9, the second transportation section 10, and the third transportation section 11. The second transportation path 44 is formed to pass through the multipurpose paper feed mechanism section 15, the second transportation section 10, and the third transportation section 11. The retransportation path 53 joins or merges with the first transportation path 43 at a junction position M1. The first transportation path 43 and the second transportation path 44 joins with each other at a junction position M2. Thus, the first transportation path 43 and the second transportation path 44 overlaps in a section downstream of the junction position M2. The transportation path 46 is formed in the overlapped section between the junction position M2 and the registration rollers 45. In other words, the transportation path 46 is a part of the first transportation path 43 and the second transportation path 44.

The first transportation section 9 is positioned downstream in the paper transportation direction with respect to the separation roller 12b of the paper feed mechanism section 7 at the forward portion of the first transportation path 43. The first transportation section 9 is positioned at a predetermined distance from the separation roller 12b and further upstream than the junction position M1 in the first transportation path 43. The first transportation section 9 includes a first transportation roller 9a that transports the paper 3, a first paper dust removing roller 9b confronting the same surface of the paper 3 as the surface confronting the separation pad 13, and a first sponge member 9c positioned below the first paper dust removing roller 9b.

The first transportation roller 9a confronts the first transportation path 43 from the inner side. The first transportation roller 9a has a metallic roller shaft 9d covered with a rubber roller 9e, and is rotatable in the direction indicated by the arrow (clockwise direction in FIG. 2) by the power transmitted from a motor (not shown).

The first paper dust removing roller 9b confronts the first transportation path 43 from the outer side. The first paper dust removing roller 9b has a metallic roller shaft 9f covered with a resin roller 9g whose surface is easily charged. The resin roller 9g is, for example, a roller of fluororesin or a roller with a fluororesin coated surface. As shown in FIG. 3(c), the first paper dust removing roller 9b is positioned in an approximately center position with respect to the first transportation roller 9a, such that the first paper dust removing roller 9b overlaps the separation pad 13 in the paper transportation direction. Accordingly, the first paper dust removing roller 9b can contact the surface of the paper 3 that has contacted the pad member 13b (the image formation surface). More specifically, the first paper dust removing roller 9b can contact a part that has contacted the pad member 13b (the approximately center part). The width of the roller 9g of the first paper dust removing roller 9b is identical to the width of a roller 10g of a second paper dust removing roller 10b described later, but smaller than the width of a roller 11g of a third paper dust removing roller 11b described later, and slightly greater than the width B of the pad member 13b.

The first paper dust removing roller 9b is driven by the first transportation roller 9a. The first paper dust removing roller 9b is rotatable in the direction indicated by the arrow, that is, the same direction as the paper transportation direction in the part confronting the first transportation path 43 (counterclockwise direction in FIGS. 1 and 2). The first paper dust removing roller 9b transports the paper 3 pinched between the first transportation roller 9a and the first paper dust removing roller 9b while removing paper dust from the paper 3.

As shown in FIG. 2, the first sponge member 9c is composed of a material such as urethane foam that easily charges the first paper dust removing roller 9b. The first sponge member 9c is positioned beneath the first paper dust removing roller 9b and is pressed against the first paper dust removing roller 9b, so as to be able to scrape off paper dust at a scraping position 9c1. The scraping position 9c1 contacts a portion of the first paper dust removing roller 9b that is a position at a lower side and an opposite side (farther side) from the first transportation path 43. Thus, the first sponge member 9c can scrape off paper dust adhering to the first paper dust removing roller 9b. The first sponge member 9c also performs frictional charging of the surface of the roller 9g of the first paper dust removing roller 9b by rubbing against the first paper dust removing roller 9b. As shown in FIG. 3(c), the width of the first sponge member 9c is slightly greater than the width of the roller 9g of the first paper dust removing roller 9b.

The second transportation section 10 is disposed downstream in the paper transportation direction with respect to the first transportation section 9 above the first transportation section 9. The second transportation section 10 is located downstream of the junction position M1 of the first transportation path 43 and the downstream end of the retransportation path 53. Further, the second transportation section 10 is located slightly downstream of the junction position M2 of the first transportation path 43 and the second transportation path 44. The second transportation section 10 includes a second transportation roller 10a that transports the paper 3, the second paper dust removing roller 10b located so as to confront the same surface as the surface confronting a multipurpose separation pad 15b described later, and a second sponge member 10c below the second paper dust removing roller 10b.

The second transportation roller 10a confronts the transportation path 46 from the outer side. The second transportation roller 10a has a metallic roller shaft 10d covered with a rubber roller be. The second transportation roller 10a is rotatable in the direction indicated by the arrow (counterclockwise direction in FIGS. 1 and 2) by the power transmitted from a motor (not shown).

The second paper dust removing roller 10b confronts the transportation path 46 from the inner side. The second paper dust removing roller 10b has a metallic roller shaft 10f covered with the resin roller 10g whose surface is easily charged, such as a roller of fluororesin or a roller with a fluororesin coated surface. As shown in FIG. 3(c), the second paper dust removing roller 10b is positioned in an approximately center position with respect to the second transportation roller 10a, such that the second paper dust removing roller 10b overlaps the pickup roller 12a and the separation roller 12b in the paper transportation direction. Accordingly, the second paper dust removing roller 10b can contact the surface of the paper 3 that has contacted the pickup roller 12a and the separation roller 12b (the surface opposite to the image formation surface). More specifically, the second paper dust removing roller 10b can contact a part that has contacted the pickup roller 12a and the separation roller 12b (the approximately center part). As described above, the width of the roller 10g of the second paper dust removing roller 10b is identical to the width of the roller 9g of the first paper dust removing roller 9b, but smaller than the width of the roller 11g of the third paper dust removing roller 11b described later, and slightly greater than the width of the pickup roller 12a and the separation roller 12b.

The second paper dust removing roller 10b is driven by the second transportation roller 10a. The second paper dust removing roller 10b is rotatable in the direction indicated by the arrow, that is, the same direction as the paper transportation direction in the part confronting the transportation path 46 (clockwise direction in FIGS. 1 and 2). The second paper dust removing roller 10b transports the paper 3 pinched between the second transportation roller 10a and the second paper dust removing roller 10b while removing paper dust from the paper 3.

The second sponge member 10c is made of a material that easily charges the second paper dust removing roller 10b, such as urethane foam. As shown in FIG. 2, the second sponge member 10c is positioned beneath the second paper dust removing roller 10b. The second sponge member 10c is pressed against the second paper dust removing roller 10b, so as to be able to scrape off paper dust on a lower side of the second paper dust removing roller 10b that is opposite from the transportation path 46. Thus, the second sponge member 10c can scrape off paper dust adhering to the second paper dust removing roller 10b. The second sponge member 10c also performs frictional charging of the surface of the roller 10g of the second paper dust removing roller 10b by rubbing against the second paper dust removing roller 10b. As shown in FIG. 3(c), the width of the second sponge member 10c is slightly greater than the width of the roller 10g of the second paper dust removing roller 10b.

As shown in FIG. 2, the third transportation section 11 is disposed downstream of the second transportation section 10 in the transportation path 46. The third transportation section 11 is located in the vicinity of the second transportation section 10. The third transportation section 11 includes a third transportation roller 11a that transports the paper 3, the third paper dust removing roller 11b disposed to sandwich the transportation path 46 and to confront the third transportation roller 11a, and a third sponge member 11c above the third paper dust removing roller 11b.

The third transportation roller 11a confronts the transportation path 46 from the inner side. The third transportation roller 11a has a metallic roller shaft 11d covered with a rubber roller 11e. The third transportation roller 11a is rotatable in the direction indicated by the arrow (clockwise direction in FIGS. 1 and 2) by the power transmitted from a motor (not shown).

The third paper dust removing roller 11b confronts the transportation path 46 from the outer side. The third paper dust removing roller 11b has a metallic roller shaft 11f covered with the resin roller 11g whose surface is easily charged, such as a roller of fluororesin or a roller with a fluororesin coated surface. As shown in FIG. 3(b), with the third paper dust removing roller 11b, the width of the roller 11g is slightly greater than the width A of the paper 3, so as to be contactable with the entire surface of the paper 3. In addition, the third paper dust removing roller 11b contacts the entirety of the surface that has contacted the pad member 13b (the image formation surface that will contact the photosensitive drum 23).

As shown in FIG. 2, the third paper dust removing roller 11b is rotatable in the direction indicated by the arrow, that is, the same direction as the paper transportation direction in the part confronting the transportation path 46 (counterclockwise direction in FIGS. 1 and 2). The third paper dust removing roller 11b transports the paper 3 pinched between the third transportation roller 11a and the third paper dust removing roller 11b while removing paper dust from the paper 3.

The third sponge member 11c is composed of a material that easily charges the third paper dust removing roller 11b, such as urethane foam. The third sponge member 11c is positioned above the third paper dust removing roller 11b. The third sponge member 11c is pressed against the third paper dust removing roller 11b, so as to scrape off paper dust at an upper side of the third paper dust removing roller 11b, which is an opposite side from the transportation path 46. Thus, the third sponge member 11c can scrape off paper dust adhering to the third paper dust removing roller 11b. The third sponge member 11c also performs frictional charging of the surface of the roller 11g of the third paper dust removing roller 11b by rubbing against the third paper dust removing roller 11b. As shown in FIG. 3(b), the width of the third sponge member 11c is slightly greater than the width of the third paper dust removing roller 11b.

As shown in FIGS. 2 and 4, the paper dust transportation section 60 includes a receiving surface 61 and an auger member 62. The receiving surface 61 receives paper dust scraped by the third sponge member 11c. The auger member 62 has an approximately cylindrical shape and transports the paper dust to the storage tank 71. The paper dust transportation section 60 is constituted as a unit that can be inserted into and removed from the laser printer 1.

The receiving surface 61 is formed into a curved concave shape for receiving the auger member 62. The receiving surface 61 is slightly wider than the width of the third paper dust removing roller 11b.

As shown in FIG. 4, the auger member 62 includes a shaft 63, and a first spiral member 64 and a second spiral member 65 both formed in a spiral shape around the shaft 63.

The first spiral member 64 is formed along the axial direction on an approximately half portion of the shaft 63. The first spiral member 64 transports paper dust in one s direction (the direction indicated by arrow X) along the axial direction of the third paper dust removing roller 11b through rotation of the shaft 63. The second spiral member 65 is formed along the axial direction on the other approximately half portion of the shaft 63 on the side opposite to the side on which the first spiral member 64 is formed. The second spiral member 65 transports paper dust in the other direction. (the direction indicated by arrow Y) along the axial direction of the third paper dust removing roller 11b through rotation of the shaft 63.

With the above-described construction, paper dust received on the receiving surface 61 is transported to both ends of the axial direction (in the directions of the arrow X and the arrow Y) by the first spiral member 64 and the second spiral member 65. The paper dust is dropped into and accumulated in the storage tank 71 located below the third transportation section 11.

As shown in FIG. 1, in the laser printer 1, the reverse transportation path 41, the retransportation path 53, the first transportation path 43, and the paper output path 42 jointly form a closed path for supplying the image forming section 5 with the paper 3 that has passed through the image forming section 5 with front and back sides thereof reversed. In other words, the reverse transportation path 41 forms a part of the closed path. The storage tank 71 is located within the closed path. An opening of the storage tank 71 is located below both the second paper dust removing roller 10b and the third paper dust removing roller 11b. Accordingly, the storage tank 71 can receive both paper dust removed by the second transportation section 10 and paper dust removed by the third transportation section 11.

In the laser printer 1, the paper 3 stacked in a pile in the paper feed tray 6 is separated and fed one sheet at a time by the cooperative action of the separation roller 12b and the separation pad 13. At the time of the paper feeding, a large amount of paper dust is generated on the image formation surface due to friction with the separation pad 13. However, when the paper 3 is first transported to the first transportation section 9, and is pinched between the first transportation roller 9a and the first paper dust removing roller 9b, the image formation surface comes into contact with the roller 9g of the first paper dust removing roller 9b. The first paper dust removing roller 9b is slightly wider than the width of the separation pad 13. Thus, paper dust generated on the paper 3 due to friction with the separation pad 13 is scraped off and electrostatically adsorbed by the roller 9g of the first paper dust removing roller 9b, because the paper dust generated on the paper 3 has a width approximately equal to the width of the pad s member 13b and because the width of the resin roller 9g is greater than the width B of the pad member 13b. Then, when the paper dust adhering to the roller 9g of the first paper dust removing roller 9b next confronts the first sponge member 9c through the rotation of the first paper dust removing roller 9b, the paper dust is scraped off by the first sponge member 9c, and falls into and is accumulated in a storage tank 72.

A large amount of paper dust is also generated on the opposite surface that is opposite to the image formation surface due to friction with the pickup roller 12a and the separation roller 12b during the paper feeding. However, when the paper 3 is transported to the second transportation section 10, and pinched between the second transportation roller 10a and the second paper dust removing roller 10b, the opposite surface comes into contact with the roller 10g of the second paper dust removing roller 10b. The second paper dust removing roller 10b is slightly wider than the width of the pickup roller 12a and the separation roller 12b. Thus, paper dust generated on the paper 3 due to friction with the pickup roller 12a and the separation roller 12b is scraped off and electrostatically adsorbed by the roller 10g of the second paper dust removing roller 10b, because the paper dust generated on the paper 3 has a width approximately equal to the width of the pickup roller 12a and the separation roller 12b and because the width of the roller 10g is greater than the width of the pickup roller 12a and the separation roller 12b. Then, when the paper dust adhering to the roller 10g of the second paper dust removing roller 10b next confronts the second sponge member 10c through the rotation of the second paper dust removing roller 10b, the paper dust is scraped off by the second sponge member 10c, and falls into and is accumulated in the storage tank 71.

Then, when the paper 3 is transported to the third transportation section 11, and pinched between the third transportation roller 11a and the third paper dust removing roller 11b, the image formation surface comes into contact with the roller 11g of the third paper dust removing roller 11b. At this time, since the third paper dust removing roller 11b is slightly wider than the width of the paper 3, paper dust originally generated on the entirety of the paper 3 during cutting of the paper 3 and so forth, and paper dust remaining after removal by the first paper dust removing roller 9b, is scraped off and electrostatically adsorbed by the roller 11g of the third paper dust removing roller 11b. Then, when the paper dust adhering to the roller 11g of the third paper dust removing roller 11b next confronts the third sponge member 11c through the rotation of the third paper dust removing roller 11b, the paper dust is scraped off by the third sponge member 11c. The scraped-off paper dust is received by the receiving surface 61, and then, through the rotation of the auger member 62, is transported to through-holes 66 at both ends of the axial direction (in the directions of the arrow X and the arrow Y), and is dropped into and accumulated in the storage tank 71 located below the third transportation section 11.

Thus, in the laser printer 1, before the paper 3 fed by the paper feed mechanism section 7 reaches the image forming section 5, part of paper dust corresponding to the width B of the pad member 13b is removed by the first paper dust removing roller 9b, part of paper dust corresponding to the width of the pickup roller 12a and the separation roller 12b is removed by the second paper dust removing roller 10b, and part of the paper dust corresponding to the width A of the paper 3 is removed by the third paper dust removing roller 11b.

Accordingly, a greater amount of paper dust generated by friction with the pad member 13b is removed by the first paper dust removing roller 9b and the third paper dust removing roller 11b, and a smaller amount of paper dust originally generated on the entirety of the paper 3 during cutting of the paper 3 and so forth is removed by the third paper dust removing roller 11b. Also, paper dust generated by friction between the pickup roller 12a and the separation roller 12b is removed by the second paper dust removing roller 10b. As a result, the first transportation section 9, the second transportation section 10, and the third transportation section 11 can remove paper dust generated on the image formation surface due to friction with the pad member 13b and paper dust originally generated, in a well-balanced manner, and can achieve uniform paper dust removal with little unevenness of removal. Moreover, the first transportation section 9, the second transportation section 10, and the third transportation section 11 also can remove paper dust generated due to friction between the pickup roller 12a and the separation roller 12b on the opposite surface to the image formation surface, and can prevent dispersion of paper dust inside the laser printer 1. Thus, the laser printer 1 can prevent contamination of the image forming section 5 due to paper dust effectively, and can form high-quality images.

As the third paper dust removing roller 11b is located downstream of the first paper dust removing roller 9b in the paper transportation direction, a greater amount of paper dust produced by friction with the pad member 13b is first removed by the first paper dust removing roller 9b, after which a smaller amount of paper dust originally produced over the entire paper 3 during cutting of the paper 3 and so forth is additionally removed by the third paper dust removing roller 11b. Thus, the laser printer 1 can achieve efficient paper dust removal based on differences in the amount of paper dust, enabling more uniform paper dust removal.

The third paper dust removing roller 11b has a width greater than the width of the paper 3, while the first paper dust removing roller 9b has a width greater than the width of the separation pad. 13 and less than the width of the third paper dust removing roller 11b. Therefore, the first paper dust removing roller 9b is not wider than necessary, allowing costs to be reduced while enabling paper dust to be removed in a well-balanced manner.

As described above, in the laser printer 1, the first paper dust removing roller 9b is located at a predetermined distance from the separation roller 12b, and is located downstream in the paper transportation direction, so as not to come into contact with the separation roller 12b.

If the first paper dust removing roller 9b is in contact with the separation roller 12b, for example, then the paper 3 to be fed next is pulled out slightly following the paper 3 fed before, due to friction between the separation roller 12b and the paper 3 fed before. In this case, if a front-end portion of the paper 3 was held between the separation roller 12b and the first paper dust removing roller 9b, and the laser printer 1 was stopped in that state, the front-end portion of the paper 3 pinched between the separation roller 12b and the first paper dust removing roller 9b might tend to curl. In such a case, when the paper 3 was next supplied, a paper jam may occur or an imperfect image may be produced on the curled front-end portion.

However, because the first paper dust removing roller 9b is located so as not to come into contact with the separation roller 12b, even if the paper 3 to be fed next should be pulled out slightly following the previously fed paper 3, the paper 3 will not be held between the separation roller 12b and the first paper dust removing roller 9b. Thus, curling of the front-end portion of the paper 3 can be prevented. Accordingly, the laser printer 1 can achieve satisfactory paper feeding at all times while also performing good paper dust removal.

In the first transportation section 9, the second transportation section 10, and the third transportation section 11, because the first sponge member 9c for scraping off paper dust adhering to the first paper dust removing roller 9b is provided to confront the first paper dust removing roller 9b, the second sponge member 10c for scraping off paper dust adhering to the second paper dust removing roller 10b is provided to confront the second paper dust removing roller 10b, and the third sponge member 11c for scraping off paper dust adhering to the third paper dust removing roller 11b is provided to confront the third paper dust removing roller 11b, paper dust adhering to the first paper dust removing roller 9b, the second paper dust removing roller 10b, and the third paper dust removing 10 roller 11b are scraped off by the first sponge member 9c, the second sponge member 10c, and the third sponge member 11c, respectively. Thus, the paper dust removal capability of the first paper dust removing roller 9b, the second paper dust removing roller 10b, and the third paper dust removing roller 11b can be maintained, and good paper dust removal over a long period can be achieved.

As described above, the widths of the first sponge member 9c, the second sponge member 10c, and the third sponge member 11c are formed so as to be slightly greater than the widths of the first paper dust removing roller 9b, the second paper dust removing roller 10b, and the third paper dust removing roller 11b, respectively. Accordingly, paper dust can be scraped satisfactorily even if paper dust on the paper 3 spreads slightly in the width direction due to contact with the first paper dust removing roller 9b, the second paper dust removing roller 10b, and the third paper dust removing roller 11b.

In the laser printer 1, the paper 3 fed by the paper feed mechanism section 7 is first pinched between the first paper dust removing roller 9b and the first transportation roller 9a and transported while paper dust is removed, then pinched between the second paper dust removing roller 10b and the second transportation roller 10a and transported while paper dust is removed, and then further pinched between the third paper dust removing roller 11b and the third transportation roller 11a and transported while paper dust is removed. The paper 3 can be transported smoothly to the image forming section 5 while paper dust can be removed in a well-balanced manner.

The third paper dust removing roller 11b is not driven by the third transportation roller 11a, but instead motive power is input to the third paper dust removing roller 11b from a separate motor (not shown) via an input gear 11h, enabling the third paper dust removing roller 11b to be driven by itself. Thus, even if torque load due to contact with the paper 3 and the third sponge member 11c is applied to the entirety of the roller 11g of the third paper dust removing roller 11b, the third paper dust removing roller 11b can be rotated smoothly by its own drive force, and good paper dust removal and transportation can be achieved.

The laser printer 1 is provided with the reverse mechanism 37, and the first transportation section 9 is located upstream of the junction position M1 of the retransportation path 53 and the first transportation path 43, while the second transportation section 10 is located downstream of the junction position M1, and the third transportation section 11 is located downstream of the second transportation section 10.

With the above-described construction, since the first paper dust removing roller 9b is located upstream of the junction position M1, the first paper dust removing roller 9b comes into contact with only the paper 3 fed from the paper feed mechanism section 7. On the other hand, since the second paper dust removing roller 10b and the third paper dust removing roller 11b are located downstream of the junction position M1, the second paper dust removing roller 10b and the third paper dust removing roller 11b come into contact with both the paper 3 fed from the paper feed mechanism section 7 and the paper 3 retransported from the retransportation path 53.

Thus, the first paper dust removing roller 9b removes only a greater amount of paper dust generated on paper fed from the paper feed mechanism section 7 by friction with the pad member 13b, while the second paper dust removing roller 10b removes paper dust generated by friction between the pickup roller 12a and the separation roller 12b and paper dust on the paper 3 retransported from the retransportation path 53. In addition, the third paper dust removing roller 11b removes paper dust on the paper 3 fed from the paper feed mechanism section 7 from which the majority of a greater amount of paper dust generated by friction with the pad member 13b has already been removed by the first paper dust removing roller 9b. The third paper dust removing roller 11b also removes paper dust of the paper 3 retransported from the retransportation path 53. Thus, paper dust can be removed effectively according to the amount of paper dust adhering to the paper 3.

The laser printer 1 in the present embodiment is provided with a single first transportation section 9, a single second transportation section 10, and a single third transportation section 11. However, a plurality of each of the first transportation section 9, the second transportation section 10, and the third transportation section 11 may be provided. Alternatively, a plurality of any one of the first transportation section 9, the second transportation section 10, or the third transportation section 11 may be provided.

The first transportation section 9 provided with the first paper dust removing roller 9b, the second transportation section 10 provided with the second paper dust removing roller 10b, and the third transportation section 11 provided with the third paper dust removing roller 11b are located in this order in the paper transportation downstream direction, but the order of the transportation sections 9, 10, and 11 may be changed. For example, the second transportation section 10, the third transportation section 11, and the first transportation section 9 may be disposed in this order in the paper transportation downstream direction.

In this case, because paper dust on the paper 3 spreads slightly in the paper width direction due to contact with the third paper dust removing roller 11b, it is desirable that the widths of the first paper dust removing roller 9b and the first sponge member 9c be greater than the widths in the above-described embodiemnt.

The locations of drive rollers and driven (follow) rollers of the first transportation section 9, the second transportation section 10, and the third transportation section 11 may also be reversed in terms of which is on the inner side and which is on the outer side of the closed path as compared with the above-described embodiment.

As shown in FIG. 1, the laser printer 1 is provided with a multipurpose tray 14 on which the paper 3 of an arbitrary size is stacked, and a multipurpose paper feed mechanism section 15 for feeding the paper 3 stacked in the multipurpose tray 14.

As shown in FIG. 2, the multipurpose paper feed mechanism section 15 includes a multipurpose paper feed roller 15a and the multipurpose separation pad 15b opposing the multipurpose paper feed roller 15a. The multipurpose paper feed mechanism section 15 is disposed at a position along the second transportation path 44. The multipurpose paper feed mechanism section 15 picks up the paper 3 by the multipurpose paper feed roller 15a, and separates the paper 3 by contacting the paper 3, so that one sheet of the paper 3 is transported downstream in the second transportation path 44.

The multipurpose separation pad 15b includes a supporting frame 15c, a multipurpose pad member 15d, and a spring 15e.

The supporting frame 15c has a one end portion 15c1 and an other end portion 15c2, both of which are formed integrally. The one end portion 15c1 is flat plate-shaped. The one end portion 15c1 is disposed below the multipurpose paper feed roller 15a and confronts the multipurpose paper feed roller 15a. The other end portion 15c2 has an L-shaped cross section, and is pivotally supported to the main casing 2 by a support shaft 15c3, such that the supporting frame 15c can be pivotally moved about the support shaft 15c3. The multipurpose pad member 15d is inset in a concave portion on a side of the one end portion 15c1 that confronts the multipurpose paper feed roller 15a. The spring 15e is disposed on the other side. The spring 15e urges the one end portion 15c1 such that the multipurpose pad member 15d is pressed against the multipurpose paper feed roller 15a.

The multipurpose pad member 15d has an approximately rectangular plate shape, includes a urethane rubber or similar elastic member, and is formed so that the width of the multipurpose separation pad 15b is smaller than the width of the paper 3. In other words, the multipurpose separation pad 15b has a width that provides contact with only the widthwise center part of the paper 3 for feeding the paper 3.

Then the topmost paper 3 stacked in the multipurpose tray 14 is pinched between the multipurpose paper feed roller 15a and the multipurpose separation pad 15b by the rotation of the multipurpose paper feed roller 15a, and is separated and fed one sheet at a time by the cooperative action of the multipurpose paper feed roller 15a and the multipurpose separation pad 15b.

The paper 3 fed from the multipurpose tray 14 passes through the second transportation path 44, and is transported to the second transportation section 10. At this time, as described above, the paper 3 is transported by being pinched between the second transportation roller 10a and the second paper dust removing roller 10b, and the surface opposite to the image formation surface comes into contact with the roller 10g of the second paper dust removing roller 10b. At this time, since the second paper dust removing roller 10b is slightly wider than the width of the multipurpose separation pad 15b, paper dust generated with a width approximately equal to the width of the multipurpose separation pad 15b on the paper 3 due to friction with the multipurpose separation pad 15b is scraped off and electrostatically adsorbed by the roller 10g. Then, when the paper dust adhering to the roller 10g next confronts the second sponge member 10c through the rotation of the second paper dust removing roller 10b, the paper dust is scraped off by the second sponge member 10c, and falls into and is accumulated in the storage tank 71.

As described above, paper dust generated with a width approximately equal to the width of the multipurpose separation pad 15b on the paper 3 due to friction with the multipurpose separation pad 15b is removed satisfactorily from the surface of the paper 3 in the second transportation section 10.

Subsequently, the paper 3 passes further through the transportation path 46, and is transported to the third transportation section 11. At this time, as described above, paper dust originally generated on the entirety of the paper 3 during cutting of the paper 3 and so forth is scraped off and electrostatically adsorbed by the roller 11g of the third paper dust removing roller 11b. Then, when the paper dust adhering to the roller 11g next confronts the third sponge member 11c through the rotation of the third paper dust removing roller 11b, the paper dust is scraped off by the third sponge member 11c. The scraped-off paper dust is received by the receiving surface 61, and then, through the rotation of the auger member 62 (FIG. 4), is transported to the both ends of the axial direction (in the directions of the arrow X and the arrow Y) of the third paper dust removing roller 11b by the first spiral member 64 and the second spiral member 65, and is dropped into and accumulated in the storage tank 71 located below the third transportation section 11.

Accordingly, paper dust originally generated on the entirety of the paper 3 during cutting of the paper 3 and so forth is removed satisfactorily from the surface of the paper 3 in the third transportation section 11.

According to the present embodiment, paper dust can be removed across the entire width of the paper 3 whichever transportation path the paper 3 passes through. Therefore, image quality degradation caused by paper dust on the paper 3 is less likely to occur. Also, as paper dust can be removed from parts in contact with the separation pad 13 whichever transportation path the paper 3 passes through, image quality degradation caused by paper dust on the paper 3 is less likely to occur.

Moreover, as paper dust adhering to the paper 3 that has passed through the reverse transportation path 41 can be removed, when images are formed on both sides, quality degradation caused by paper dust on the paper 3 is less likely to occur for both side.

Further, the paper 3 fed from the paper supply cassette 4 passes through the first transportation section 9 provided with the first paper dust removing roller 9b, the second transportation section 10 provided with the second paper dust removing roller 10b, and the third transportation section 11 provided with the third paper dust removing roller 11b, along the first transportation path 43. Thus, the paper dust on the paper 3 passing through the first transportation path 43 is thoroughly removed, and quality degradation of images caused by paper dust on the paper 3 is less likely to occur. On the other hand, the paper 3 fed from the multipurpose tray 14 passes through the second transportation section 10 provided with the second paper dust removing roller 10b and the third transportation section 11 provided with the third paper dust removing roller 11b, along the second transportation path 44. Thus, the paper dust on the paper 3 passing through the second transportation path 44 is thoroughly removed, and quality degradation caused by the paper dust is less likely to occur.

Further, the storage tank 71 that holds paper dust is disposed inside the closed path that is partly formed by the reverse transportation path 41, and is located below the second transportation section 10 and the third transportation section 11. Thus, because it is not necessary to provide two separate storage tanks for the second transportation section 10 and the third transportation section 11, a space can be used effectively, and the laser printer 1 can be made smaller. In addition, costs can be reduced through a reduction in the number of component parts.

In the above-described embodiment, the storage tank 71 is located below the second transportation section 10 and the third transportation section 11, and can hold dust scraped off and dropped by both the second paper dust removing roller 10b and the third paper dust removing roller 11b. However, tanks may be provided separately for the second transportation section 10 and the third transportation section 11.

While the invention has been described in detail with reference to the specific embodiment thereof, it would be apparent to those skilled in the art that various changes and modifications may be made therein without departing from the spirit of the invention.

For example, the above-described embodiment relates to a laser printer. However, the present invention is not limited to a laser printer and can also be applied to different types of printers such as an ink-jet type printer, an image reading device, or another device having the same kind of transportation paths as the above-described embodiment.

Further, in the above-described embodiment, the laser printer 1 has a reverse transportation path. However, the laser printer may be a printer that does not have a reverse transportation path.

1. An image forming device comprising:
an image forming section forming an image on an image formation surface of a recording medium, the recording medium having a width in a widthwise direction orthogonal to a recording-medium transportation direction:
a plurality of recording-medium supply units each supplying the image forming section with the recoding medium;
a transportation guide forming a plurality of transportation paths, each transportation path connecting a corresponding one of the plurality of recording-medium supply units to the image forming section, the recording medium being transported from each recording-medium supply unit to the image forming section in the recording-medium transportation direction, the plurality of transportation paths joining together to provide a single main transportation path reaching the image forming section;
a full-width cleaning member disposed in the single main transportation path, the full-width cleaning member being contactable with the image formation surface of the recording medium, the full-width cleaning member having a full-width cleaning portion for removing foreign matter adhering to the image formation surface of the recording medium, the full-width cleaning portion having a first width greater than the width of the recording medium in the widthwise direction;
a plurality of recording-medium separating members each disposed at a position, in each of the plurality of transportation paths, between a corresponding recording-medium supply unit and the full-width cleaning member, each recording-medium separating member being contactable with one surface of the recording medium, thereby separating only one sheet of the recording medium to be transported downstream, each recording-medium separating member having a second width in the widthwise direction smaller than the width of the recording medium; and
at least one partial cleaning member provided for each recording-medium separating member, the at least one partial cleaning member being disposed at a position, in a corresponding transportation path, between a corresponding recording-medium separating member and the image forming section, each partial cleaning member being contactable with the one surface of the recording medium, each partial cleaning member having a partial cleaning portion for removing foreign matter adhering to the one surface of the recording medium, the partial cleaning portion having a third width greater than the second width of the corresponding recording-medium separating member.

2. The image forming device as claimed in claim 1, further comprising a reverse guide that forms a reverse transportation path for supplying the image forming section with the recording medium that has passed through the image forming section with front and back sides thereof reversed:
wherein the plurality of transportation paths includes a first transportation path and a second transportation path;
wherein the reverse transportation path joins with the first transportation path at a first junction position;
wherein the first transportation path and the second transportation path join with each other at a second junction position to provide the single main transportation path, the second junction position being positioned downstream of the first junction position; and
wherein the full-width cleaning member is positioned in the single main transportation path between the second junction position and the image forming section.

3. The image forming device as claimed in claim 1, further comprising a reverse guide that forms a reverse transportation path for supplying the image forming section with the recording medium that has passed through the image forming section with front and back sides thereof reversed;
wherein the reverse transportation path joins with one of the plurality of transportation paths at a position upstream of both the full-width cleaning member and at least the partial cleaning member located nearest to the full-width cleaning member.

4. The image forming device as claimed in claim 3, further comprising a storage tank storing the foreign matter removed from the recording medium by the full-width cleaning member;
wherein the reverse transportation path forms a part of a closed path for supplying the image forming section with the recording medium that has passed through the image forming section with front and back sides thereof reversed; and
wherein the storage tank is disposed inside the closed path.

5. The image forming device as claimed in claim 1, further comprising a rotation member provided for each recording-medium separating member, the rotation member having a surface with a coefficient of friction that is higher than a coefficient of friction of the recording-medium separating member, the rotation member transporting the recording medium downstream by pinching the recording medium in cooperation with the recording-medium separating member.

6. The image forming device as claimed in claim 1, wherein the plurality of recording-medium supply units includes a recording-medium feed tray and a recording-medium supply cassette, the recording-medium supply cassette being capable of accommodating a plurality of recording media in a stacked form.

7. The image forming device as claimed in claim 1, wherein the plurality of transportation paths includes a first transportation path and a second transportation path, the first and second transportation paths joining with each other at a predetermined junction position to provide the single main transportation path;
wherein, in the first transportation path, the at least one partial cleaning member is disposed upstream of the predetermined junction position; and
wherein, in the second transportation path, the at least one partial cleaning member is disposed downstream of the predetermined junction position.

8. The image forming device as claimed in claim 7, wherein the recording medium has a first surface and a second surface opposite to the first surface;
wherein the at least one partial cleaning member provided in the first transportation path is disposed to confront the first surface; and
wherein the at least one partial cleaning member provided in the second transportation path is disposed to confront the second surface.

9. The image forming device as claimed in claim 7, wherein the plurality of recording-medium supply units includes a recording-medium feed tray and a recording-medium supply cassette, the recording-medium supply cassette being capable of accommodating a plurality of recording media in a stacked form;
wherein the first transportation path connects the recording-medium supply cassette to the image forming section; and
wherein the second transportation path connects the recording-medium feed tray to the image forming section.

10. The image forming device as claimed in claim 1, further comprising a storage tank storing the foreign matter removed from the recording medium by the full-width cleaning member.

11. The image forming device as claimed in claim 10, wherein the storage tank stores both the foreign matter removed from the recording medium by the full-width cleaning member and the foreign matter removed from the recording medium by at least one of the partial cleaning members.

12. The image forming device as claimed in claim 1, wherein the image forming section includes:
a light source emitting a light beam;
an image bearing member on which an electrostatic latent image is formed by the light beam emitted from the light source;
a developing section developing, with developer, the electrostatic latent image formed on the image bearing member and forming a developed image; and
a transfer section transferring the developed image formed on the image bearing member to the recording medium.
